(19) United States
(12) Patent Application Publication
(10) Pub. No.: US 2009/0013259 A1
(43) Pub. Date: Jan. 8, 2009

(54) SERVER CONSOLIDATION USING TABULAR DATA DRIVEN PROCESSES FILLED AT LEAST IN PART USING AUTOMATICALLY GENERATED INFERRED DATA

(75) Inventor: Dore I. TEICHMAN, Lake Worth, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/774,320

(22) Filed: Jul. 6, 2007

(51) Int. Cl. G06F 3/048; G06F 15/173; G06F 17/00

(52) U.S. Cl. 715/738; 709/223

(57) ABSTRACT

The present invention discloses a consolidation software program that includes a set of tables, a GUI, an inference engine, and an output generation engine. The set of tables can include one or more tables that define characteristics of a network. The tables can include entries for each server in the network and can also specify hardware characteristics of each server. The GUI can visually present the tables in an interactive manner, which permits users to add/change table values. The inference engine can automatically generate values used to populate uncompleted entries of the set of tables based upon values of other entries in the set of tables. The output generation engine can automatically generate at least one alternative configuration to the network configuration based upon table values that include at least one inferred value generated by the inference engine. The alternative configuration can consolidate servers relative to the network configuration.

### BACKGROUND

1. Field of the Invention

The present invention relates to the field of Server Consolidation (SCON) tools and, more specifically, to consolidation of computing assets using tabular data filled at least in part using automatically generated inferred data.

2. Description of the Related. Art

A majority of business enterprises utilize a set of servers that together implement a set of core business operations, which can include employee-facing applications, customer-facing applications, database systems for business records and other internal resources, business partner interaction resources, and/or the like. The set of servers and the software, which these servers execute, can be very expensive to operate, manage, maintain, and upgrade. Overall information technology (IT) infrastructure cost can often be minimized by intelligently consolidating computing resources through a server consolidation effort.

Server consolidation implies combining workloads from separate machines or applications into a smaller number of systems or applications. The practice of server consolidation was developed in response to the problem of server sprawl, a situation in which multiple, under-utilized servers take up more space and consume more resources than can be justified by their workload. There are several forms of consolidation. Heterogeneous workloads from multiple servers can be moved to a single larger server. A simple variant of this combination is to use software virtualization to decouple workload and its data from its physical platform, which results in a same number of active operating system (OS) computer images, but a decrease in physical machines. When simple machine per image virtualization is used, software licenses are typically required for each OS image, which results in little savings with regard to software licenses. Additionally, the work effort required to operationally maintain the “virtual server” is about the same as the original physical server. During consolidation efforts, multiple workloads can also be combined under a single OS reducing OS images. With more analysis, multiple workload instances of the same application software can be combined into a single instance, such as HTTP server instances. Finally, multiple applications, such as email systems or database applications can be combined into a single system.

Intelligent server consolidation efforts can be complex endeavors involving business tradeoffs with regard to expandability, flexibility, reliability, upgradeability, upfront costs, maintenance costs, and other factors. Analysis tools exist that are designed to present a set of consolidation options to decision makers. These current tools, however, suffer from a myriad of shortcomings, which minimize their utility for fulfilling their intended purposes.

For example, current tools do not attempt to characterize an enterprise's servers in a manner that permits executive decision makers to understand how servers are deployed in terms of size, technology age, speed, or role. Further, consolidation tools are often only provide technologically oriented interfaces, which are cumbersome or incomprehensible to executive decision makers. Thus, executive decision makers require an interpretation of tool results from a technical expert whose interpretation and perspectives often include biases and assumptions that hamper the decision makers' ability to make informed choices.

Additionally, many current tools require intense amounts of highly specific data to operate, which is often not available. When the data is not entered, the tools cannot work. When improper data is entered due to confusion or lack of ability to provide data as requested, tool generated results are inaccurate or misleading. Further, many consolidation tools are strongly biased to provide virtualization based consolidation solutions, even when that infrastructure consolidation effort would be better served by OS image consolidation. Existing tools also segment server groupings in accordance with existing network topography limitations, even when a new network topography should exist in an aftermath of a server consolidation effort. For example, existing tools do not analyze whether a consolidation should occur across firewall boundaries and whether new firewall boundaries are appropriate for a post consolidation IT infrastructure.

What is needed is a new consolidation tool designed to be used by decision makers, which minimizes or corrects the shortcomings of conventionally constructed tools. For example, it would be advantageous to utilize an interactive interface familiar to a decision maker, instead of one solely focused upon IT experts. Ideally, a new tool would be able to accept scant data regarding pre-existing environments and make educated guesses within configurable limits to permit an accurate analysis effort to be conducted within acceptable margins of error. It would also be desirable if the amount of required input information and a corresponding margin of error were established in a sliding scale fashion, so that accurate initial consolidation decisions can be made based upon available information., which can be supplemented to reduce a margin of error as further decisions related to a consolidation effort are made.

### SUMMARY OF THE INVENTION

The present invention discloses a server consolidation solution that utilizes programmatic routines driven by tabular input, such as input expressible within a spreadsheet. Tabular input fields can be manually filled and/or can be filled automatically using software tools, which automatically analyze a physical network to derive metrics. Values for unfilled tabular fields can be inferred based upon the filled fields using a rule base developed from substantial statistical analysis of hardware deployed in the industry that is updated heuristically as the tool experiences new hardware, and or rule base. In one embodiment, wizards can be linked to the set of inferred entries, which can optionally prompt a user for additional information to minimize a margin of error associated with inferring values for missing table fields. Once a table is sufficiently filled, charts, graphs, and summary sheets can be created from the tabular input, which together represent one or more consolidation solutions or portions thereof.

Notably, the solution uses tabular entries, charts, and reports with which most businesses executives are familiar. In one embodiment, the tabular input, charts, graphs, and the like, can be linked to and can leverage capabilities of one or more commercial off-the-shelf (COTS) products, such as a spreadsheet program (e.g., LOTUS 1-2-3), a database program (e.g., DB2 database), a reporting program (e.g., CRYSTAL REPORTS), and the like. That is, one implementation of the solution is as a plug-in, a set of macros, a set of rules, a set of reports, a set of programmatic routines, and the like, that are added to a COTS program/suite to add a new server consolidation capability to the COTS software.

In one embodiment, the disclosed consolidation tool can be capable of launching “web crawler” search engines to identify and price the current hardware on the floor and to also identify and price similar hardware options currently available. For instance, for a GIZTECH V420, the tool should identify “for sale” V420s currently being marketed on the internet. Using this method, existing data center hardware can be classified and a real hardware replacement cost valuation developed.

The present invention can be implemented in accordance with numerous aspects consistent with the material presented herein. For example, one aspect of the present invention can include a server consolidation method, which utilizes tabular data that includes at least one inferred value to generate server consolidation output. In the method, characteristics of a physical computing network of an entity can be expressed as a set of tabular data. The physical computing network can include one or more linked servers. Each server can have a set of associated server capabilities, which interoperate to define a network capability. The network capability can respond to a network processing requirement of the entity The tabular data can include entries that characterize the server capabilities, the network capability, and the network processing requirement. The tabular data can be presented within an editable graphical user interface (GUI), such as a spreadsheet.

A user input can be received from the GUI, which triggers a tabular data inference event. This event can cause a program to execute to infer values for one or more of the previously uncompleted entries based upon values of the at least one completed entry. After the set of programmatic instructions execute, each previously uncompleted entry that now includes inferred values can be thereafter referred to as an inferred entry.

A consolidation output generation event can be detected that causes a data driven programmatic action to execute, which produces consolidation output based upon values of the completed entries and the inferred entries. The consolidation output can specify a proposed modification to the physical computing network, which will satisfy the network processing requirement or that will satisfy a modification to the network processing requirement (e.g., new network processing requirement) that is quantified by the tabular data. This proposed modification can consolidate an original set of servers into new and smaller set of server and fewer server instances logical or physical.

Another aspect of the present invention can include a consolidation software program that includes a set of tables, a GUI, an inference engine, and an output generation engine. The set of tables can include one or more tables that together define network parameters for a network configuration. The tables can include entries for each server in the network and can also specify hardware characteristics of each server. The GUI can visually present the tables in an interactive manner, which permits users to add/change table values. The inference engine can automatically generate values used to populate uncompleted entries of the set of tables based upon values of other entries in the set of tables. The output generation engine can automatically generate at least one alternative configuration to the network configuration based upon table values that include at least one inferred value generated by the inference engine. The alternative configuration can consolidate servers relative to the network configuration.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for performing server consolidation using a tabular data driven process, where the tables are filled at least in part from automatically inferred data in accordance with an embodiment of the inventive arrangements disclosed herein.

FIG. 2 is a schematic diagram 200 of an inference engine 220 used for server consolidation purposes in accordance with an embodiment of the inventive arrangements disclosed herein.

FIG. 3 is a flow chart of a method for performing server consolidation using a tabular data driven process, where the tables are filled at least in part from automatically inferred data in accordance with an embodiment of the inventive arrangements disclosed herein.

### DETAILED DESCRIPTION OF THE INVENTION

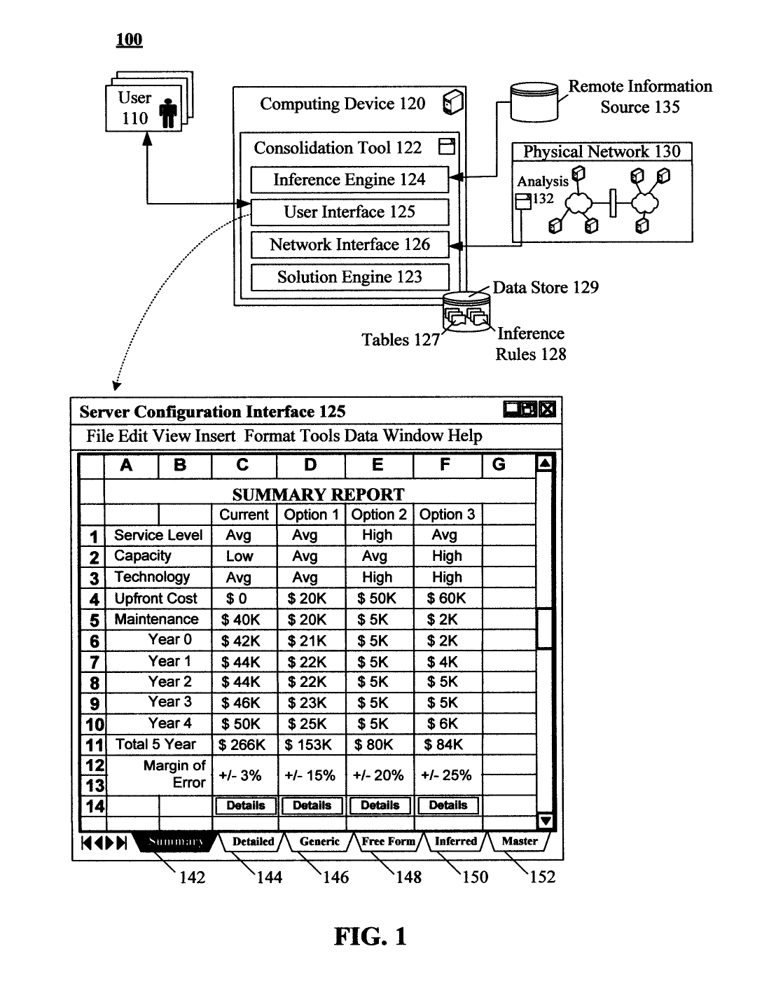

FIG. 1 is a schematic diagram of a system 100 for performing server consolidation using a tabular data driven process, where tables 127 are filled at least in part from automatically inferred data in accordance with an embodiment of the inventive arrangements disclosed herein. The ability of system 100 to infer data via an inference engine 124 permits complete analysis to be performed within some acceptable margin of error by a consolidation tool 122 even when available data concerning a network is scant. When information of the tables 127 is more complete, the consolidation tool 122 can perform a consolidation analysis with greater accuracy, and within a lower overall margin of error.

In one embodiment, portions of the tool 122 can be implemented as commercial off-the-shelf (COTS) components, such as a commercial spreadsheet application. Use of COTS components can enable users 110 to use a tool with which they may already be familiar, which lowers training costs and improves user (110) satisfaction. For example, different ones of the tables 127 used by the consolidation tool 122 can be expressed as spreadsheet tabs (142-152), which the users 110 can utilize to add/edit table 127 data. User configurable reports, such as summary 142, can be easily constructed from the tables 127. Leveraging pre-existing capabilities of COTS components potentially lowers the development and maintenance cost of the consolidation tool 122, while still providing a rich feature set. Appreciably, instead of COTS components, each component illustrated in system 100 can be a customized component specifically designed for consolidation purposes.

To elaborate upon system 100, the user 110 can interact with a computing device 120, which hosts the consolidation tool 122. The consolidation tool 122 can include a set of engines/interfaces (124-126), which are used to construct a “master” table 152 or data set, which defines characteristics of a physical computing network 130. The physical network 130 can be a network for which a server consolidation analysis is being performed. That is, the purpose of the master table 152 is to provide sufficient data for a solution engine 123 to optimize a server environment (130). In a simple implementation (not shown), the master table 152 can be a single table within which all input is added/edited.

When the master table 152 is directly utilized, tables 144-150 are unnecessary. The purpose of tables 144-150 in system 100 is to provide user-friendly input tables for users who may be confused or unable to utilize fields of the master table 152, which is formatted for use by the solution engine 123. That is, many users 110 will be able to complete generic 146 or free form 148 entries (which can be converted into master table 152 values), yet would be unable to understand and/or complete entries of the master table 152. The inference engine 124 can be used to convert user provided values from any of the tables 144-150 to master table 152 values. The inference engine 124 can also create suitable values for unfilled entries of table 152 based upon known values even when no directly corresponding entries for the unfilled values exist in other tables 144-150.

An optimized environment 130 can be one where workloads from multiple servers are moved to fewer servers. Optimizing or consolidating a network 130 can also involve virtualizing one or more physical servers using virtualization technologies, such as those provided by VMWARE and other venders. Consolidation/optimization solutions generated by the solution engine 123 can reduce an overall cost of a network 130.

For example, summary 142 shows summary output, which is able to be generated by the solution engine 123 for ways to consolidate a network 130 defined by master 152 table. The summary 142 shows a report for a current configuration (e.g. labeled as Current) and for three proposed configurations (e.g., labeled Option 1, Option 2, and Option 3). For each network configuration, values representing a provided service level, capacity, technology, upfront cost, maintenance costs, and the like can be determined. Each configuration can also be associated with a margin of error, which represents an error caused by an uncertainty of master table 152 data. Details for each proposed configuration can be selected. Additionally, user configurable charts, graphs, worksheets, and the like can be presented for consolidation solutions.

A format of the summary 142 and details of generated consolidation solutions can be highly dependent upon implementation details of the solution engine 123. The solution engine 123 can be any software program, which is able to process the network characteristics contained in the master table 152 to generate consolidation solutions. For example, the solution engine 123 can be implemented as IBM's Consolidation, Discovery and Analysis Tool (CDAT), HP's Consolidation Modeling Tool and Discovery service, DELL's Infrastructure Consolidation Readiness Assessment tools, and any of a variety of other Server Consolidation (SCON) tools. When the set of tools used to implement the solution engine 123 is known, the master table 152 can be formatted to be directly compatible. Otherwise, the master table 152 can be configured in a default format designed to be compatible with many different SCON tools.

The consolidation tool 122 can utilize an inference engine 124 to generate the master table 152 from one or more other input tables 144-150. Input included in the tables 144-150 can be manually provided by a user 110, can be automatically provided by an analysis tool 132, and/or can be obtained at least in part from a remote information source 135. The analysis tool 132 can be any tool that monitors network 130 and automatically extracts information to characterize the network 130. For example, the analysis tool 132 can include PLATESPIN's POWER RECON, VMware's CAPACITY PLANNER, and other such SCON tools.

The various input tables 144-150 can include network characterizing information that is redundant among the various tables. For example, the detailed table 144 can specify a database server as a Quad OPTERON 850 computer with 16 MB of DDR2 RAM and one TB of hard drive space. The generic table 146 can characterize the same database server as a mid-range data server hosting INFORMIX software and handling hundreds of thousands of records. The free form table 148 can permit a user to enter component model numbers, names, and other known information. The inference engine 124 can data-mine the tree form 148 information, which may be combined with other information sources 135, such as vender Web sites that provide performance specifications for components by model number. The inferred table 150 visually shows values that the inference engine 124 has generated, which can be edited by a user 110 in one contemplated embodiment.

The inference engine 124 generates inferred data 150 based upon a set of configurable inference rules 128. These rules 128 can make educated guesses about unknown components based upon known components. For example, if a network center includes three fully defined servers of similar configurations and one unknown server, and if the unknown server is specified by a user 110 within a generic table 146 as being approximately equivalent to one of the three known servers, the inference engine 124 can infer that the unknown server has characteristics similar to the known three servers. The more information that is provided by users 110 and automated sources 132, 135 for network characterization purposes, the more accurate the results from the inference engine 124 can be.

In one embodiment one or more of the inference rules 128 can be heuristically defined. Weights associated with the heuristics can be dynamically adjusted based upon a training loop. That is, the rules 128 are able to self-adjust parameters, as previously unknown network components become known. Therefore, weights used to generate inferred input confirmed to be accurate by later data entries can be increased, while weights that generated inaccurate data can be decreased over time. Accordingly, in one embodiment, performance of the inference engine 124 should automatically improve as the consolidation tool 122 is used.

The tables 127 and rules 128 can be stored in a data store 129. Data stores 129 and 135 can be physically implemented within any type of hardware including, but not limited to, a magnetic disk, an optical disk, a semiconductor memory, a digitally encoded plastic memory, or any other recording medium. Each data store 129 and 135 can be a stand-alone storage unit as well as a storage unit formed from a plurality of physical devices, which may be remotely located from one another. Additionally, information can be stored within each data store 129 and 135 in a variety of manners. For example, information can be stored within a database structure or can be stored within one or more files of a file storage system, where each file may or may not be indexed for information searching purposes.

Although shown as a single device 120 for simplicity, the computing device 120 can be implemented as one or more communicatively linked computing devices. Each device 120 can host a portion of the software represented by the consolidation tool 122. Hence, the user interface 125, the solution engine 123, and the inference engine 124 can each execute within a separate computer/server, which communicate with one another.

The computing device 120 and/or component systems represented by the computing device 120 can interconnect with each other, source 135, and/or analysis tools 132 via a network (not shown). The network can include any hardware/software/and firmware necessary to convey digital content encoded within carrier waves. Content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

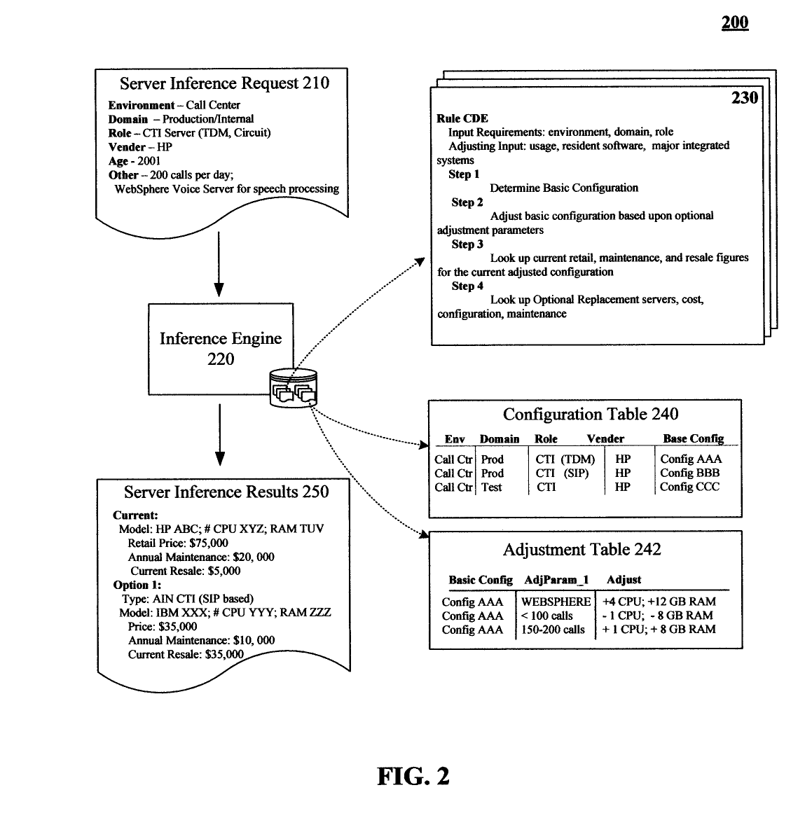

FIG. 2 is a schematic diagram 200 of an inference engine 220 used for server consolidation purposes in accordance with an embodiment of the inventive arrangements disclosed herein. In diagram 200, a server inference request 210 can specify a set of conditions for a server, which is processed by the inference engine 220 to generate server inference results 250. The processing by the engine 220 can be based upon a set of rules 230 and content stored in indexed information tables 240-242. In one embodiment, the content of the request 210 can be automatically obtained from a master table, such as master table 152 of system 100, and the server inference results 250 can be output in tabular form, as described in system 100.

The inference engine 220 takes advantage of fact that server/implementation specifics can generally be characterized by function. Further, each function in a non-consolidated computing environment is typically performed by a distinct type of server. Experienced IT professionals who have participated in multiple consolidation efforts are often good at “eyeballing” or estimating configuration specifics based upon past experience. These professionals can know, for example, that a data center with one hundred and sixty application servers and a certain number of calls handled per day typically use servers configured in a particular manner. This server configuration is very different than that of a server used in a back-office loan processing center. The inference engine 220 utilizes a configurable set of rules 230, which contain the heuristic knowledge IT professionals have acquired through experience with consolidation projects.

It should be appreciated that rule 230 specifics change over time as different default hardware/software configurations are used to perform a given general function. For example, a legacy Computer Telephony Integration (CTI) server can handle voice transmissions within call centers based upon a Time Division Modulation (TDM) circuit-switched network and can handle access through a public, switched telephone network (PSTN). Handling CTI functions in this manner requires a definable set of computing resources, and an unknown implementation will fall within a designated range for configuration parameters required to fulfill the CTI functions using TDM technology.

Newer CTI servers, however, handle voice transmissions using Internet Protocol (IP) based technologies and protocols. That is, voice transmissions can be Session Initiated Protocol (SIP) based communications, such as Voice over Internet Protocol (VOIP) communications. Switching and Call Control functions can be performed by an Advanced Intelligent Network (AIM) telephony system. Configuration specification for an IP based CTI server is very different than those of a TDM based CTI server, which can be accounted for in the rules 230 and tables 240-242.

In one embodiment, the rules 230 and tables 240-242 of the inference engine 220 can be designed to produce results 250 based on input 210 defining an environment and a domain for a server or set of servers. Each of these functions requires a certain minimum set of hardware/software resources. A maximum set of hardware/software resources is also present, since above a certain threshold excess capacity represents wasted resources and unnecessary expense. Within these definable thresholds, an average configuration exists. Statistically, results based upon these averages will be reasonably close to underlying hardware and software used in a particular instance. Thus, the inference engine 220 can accurately infer network specifics within an acceptable margin of error assuming implementation standards (240-242) and corresponding rules (230) are annotated, and that a minimal input set (210) to drive these rules is provided.

As shown, the environment parameter used by the inference engine 220 defines an area of use, such as call center, database server, back office, internal agent use, external customer use, and the like. A domain can be specified that denotes whether the equipment is used for production purposes, development purposes, quality assurance purposes, spare purposes, test purposes, and the like. Domains have historically been separated into different fire-wall zones. Diagram 200 permits these fire-wall zones to be defined, but does not constrain consolidation solutions by fire-wall boundaries. For example, it can be beneficial to produce consolidation results 250 that combine applications having similar “burst length” across memory, controllers, and channels to yield better queuing performance than would otherwise be possible. Other times, corporate policy, federal regulations, and/or security considerations can require fire-wall boundaries be enforced, which can be programmatically specified with in the rules 230 and tables 240-242 as suitable for a given scenario.

The inference engine 220 can also utilize several roles to denote a server's purpose. Roles can include, but are not limited to, Web server, application server, database server, infrastructure, mail, messaging, file server, print server, mixed server, and other. It should be appreciated that the various categories and category enumerations can be modified as appropriate for different consolidation tasks and as different technologies emerge.

To illustrate by example, the server inference request 210 can specify a call center environment, a production domain, and a CTI server role that uses TDM technology. Additional known information can include HP as a vender, 2001 as an equipment age, an average call volume of two hundred calls per day, and an interface requirement with WEBSPHERE voice server. The inference engine 220 can match this specification with a Rule CDE 230, which has input requirements matching the received input 210. A variety of roles can exist, which are selectively triggered depending upon information available within the request 210. The Rule CDE 230 can also adjust system parameters base upon a set of optional inputs, like usage, resident software, major integrated systems, and the like.

A first step executed by Rule CDE 230 can be to determine a base configuration table, which can utilize configuration table 240. As shown, in table 240, Configuration AAA can be associated with a record having an environment value of call center, a domain value of production, and a role of CTI (TDM). The second step of Rule CDE 230 can be to adjust the basic configuration based upon optional input, which can utilize values of adjustment table 242.

In table 242, when a WEBSPHERE interface is indicated, the base configuration can be adjusted by adding four additional CPU's and twelve additional GB of RAM. When the average call volume is between one hundred and fifty and two hundred calls, the base configuration can be increased by an additional CPU unit and by eight GB of RAM. Thus, the adjustments in Step 2 of Rule CDE 230 add five CPUs and twenty GB of RAM to the base configuration of Configuration AAA.

In Step 3 of the rule, current rental, maintenance, and resale figures appropriate for the adjusted configuration can be determined. In one embodiment, this step can utilize web crawling technology to gather information from a remote source, such as source 135 of system 100. In another embodiment, a table of common configuration values can be locally maintained and intermittently updated to similarly provide updated valuation information. In Step 4, optional replacement servers and their associated parameters, such as purchase costs, maintenance cost, etc. can be obtained. Step 4 can also create a suggested configuration plan for implementing the suggested replacement servers to handle the load of the current physical resources.

After the Rule CDE 230 executes, the inference engine 220 can output server inference results 250. The results 250 can specify details for a current system, a system price, annual maintenance cost, current resale value, and the like. The results 250 can also specify one or more options, the option type, hardware specifics, retail price, annual maintenance cost, and the like.

It should be appreciated that the details of the rules 230 and tables 240-242 are for illustrative purposes only and are not intended to be a constraint upon the disclosed invention. By nature, the rules 230 of the inference engine 220 are flexible as are the specifics for the tables 240, 242 so that emerging technologies and inevitable changes to implementation practices can be accommodated.

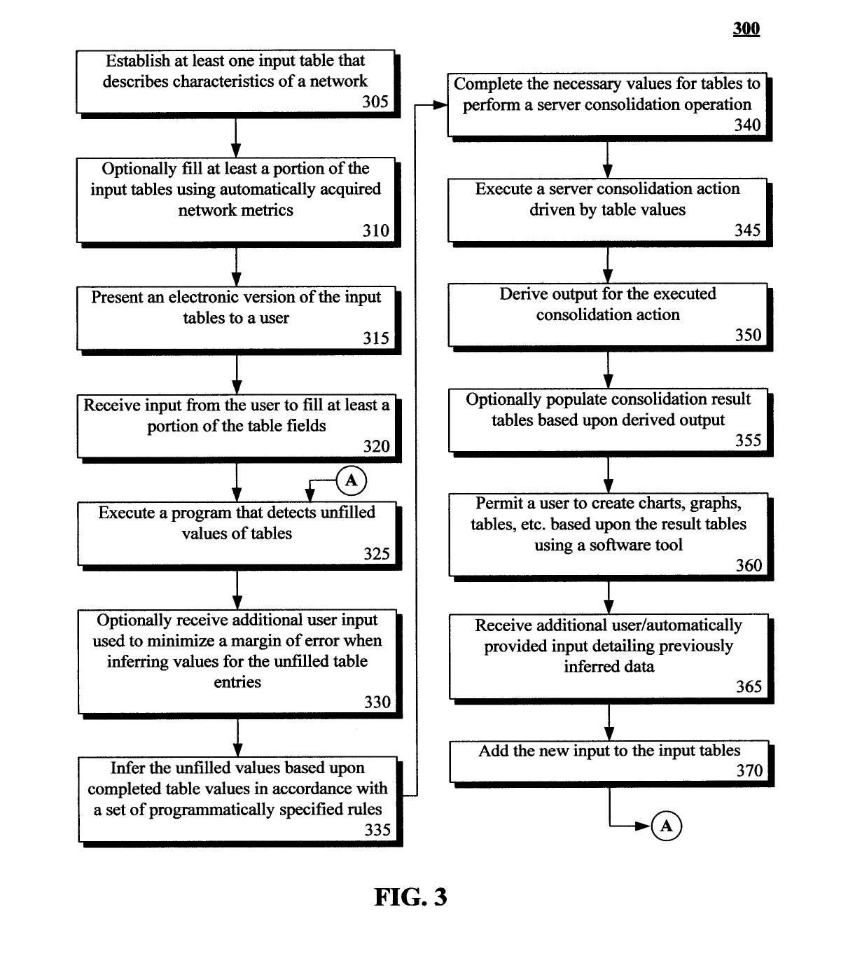

FIG. 3 is a flow chart of a method 300 for performing server consolidation using a tabular data driven process, where the tables are filled at least in part from automatically inferred data in accordance with an embodiment of the inventive arrangements disclosed herein. The method 300 can be performed in the context of system 100 or any table driven consolidation system.

The method 300 can begin in step 305, where at least one input table that describes characteristics of a network can be established. In one embodiment, these tables can be a set of interlinked spreadsheet tables or worksheets, such as those described for interface 125. These interlinked worksheets can redundantly refer to the same network components at various levels of granularity. For example, one table can specify hardware/software items for networked servers by brand/model, such as specifying an IBM pSeries Model 630 Model 6C4 server. Another table can specify the same server by components such as eight POWER-4 processors, six MB RAM, and seventy-eight GB SCSI storage. Still another table can specify the same server by performance characteristics, using benchmark scores. Yet another table can specify the server by purpose and/or software, such as UNIX platform Web server hosting Apache Web server. A different table can use free form input, such as IBM mid-range p-series Web server details unknown. Another table can use generic criteria, such as mid-level legacy mainframe server or cluster of two dual processor WINDOWS 2003 SERVER machines. In other embodiments, the set of tables can include one or more database tables, indexed files of tabular data, and other data storage mechanisms. Cross-referencing the values of the tables/spreadsheet can form a coherent picture of a physical network.

In optional step 310, at least a portion of the input tables can be filled by automatically acquired network metrics. In step 315, an electronic version of the input tables can be presented to a user, such as presenting a formatted spreadsheet for specifying network components. In step 320, input can be received from the user to complete some of the table fields. In step 325, a program linked to the tables can execute that detects unfilled values of the tables. These unfilled values can be values of a “master” table to which the other input table(s) are linked. The master table can be a table, whose completion is required before a consolidation action (of step 345) is able to properly execute.

In optional step 330, additional user input can be received responsive to prompts relating to the unfilled data. These prompts can be used to minimize a margin of error when inferring values for the unfilled entries. For example, a prompt can ask whether an under specified server named Server ABC is more like a Server BBB or a Server CCC. In step 335, the detected, unfilled values can be automatically inferred based upon completed table values in accordance with a set of programmatically specified rules. These rules can be configured for a particular physical system by an authorized administrator.

In another embodiment, different sets of network profiles can be established, where each profile is associated with a set of inference rules. For example, a corporate enterprise profile would be associated with a different set of inference rules than a mid-range small business profile. The inference profile used in step 335 can be automatically selected based upon already completed network characteristic entries based upon an assumption that the entire network is formed using similar components.

In step 340., necessary values for the “master” table can be completed based upon both the inferred values and input values. Each inferred value can result in a specifiable margin of error for a consolidation solution, which can be statistically calculated based upon one or more inferred values. In step 345, a server consolidation action can execute, which is a software action driven by the master table. In step 350, output can be derived for the executed consolidation action. For example, the consolidation action can indicate that an original computing environment of thirty POWER-4 processors can be replaced by different equipment having sixteen POWER-5 processors, where the different equipment is part of an automatically generated consolidation server solution.

In step 355, one or more output tables can be populated based upon results of the consolidation action. The output tables can represent configured servers/components of a proposed consolidated solution. In one embodiment, the output tables can be presented within the same software tool, which was used to present the input tables. This software tool can include numerous interactive reporting mechanisms, such as charts, graphs, and summaries that the tool is able to generate from the output tables. Further, a series of reports and/or report configuration tools, such as SQL queries tools can also be part of the software tool. In step 360, a user can be permitted to create charts, graphs, tables, and the like using the software tool based upon the data of the output tables.

In step 365, additional user provided or automatically provided input can be received. This additional input can represent a further refinement of network characteristics, which were previously inferred. In step 370, the new input can be placed in the input tables. The method can progress from step 370 to step 325, where a program can again detect unfilled values of the input table. It should be appreciated that steps 365 and 370 show an information refinement loop, which can be more fully completed throughout various phases of a consolidation effort as additional information becomes available. The additional information will generally lower a margin of error associated with automatically generated server consolidation options. Thus, executive decisions can be made regarding consolidation options at early stages in a consolidation effort, which can result in a termination of the otherwise expensive effort.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A server consolidation method comprising:
expressing characteristics of a physical computing network of an entity as a set of tabular data, said physical computing network comprising a plurality of communicatively linked servers, each having characteristic server capabilities that interoperate to define a network capability, said network capability responding to a network processing requirement of the entity, wherein said tabular data includes entries that characterize the server capabilities, the network capability, and the network processing requirement;
presenting the tabular data within an editable graphical user interface, said tabular data comprising at least one completed entry and at least one uncompleted entry;
receiving an input from the graphical user interface, which triggers a tabular data inference event;
responsive to an occurrence of the data inference event, executing a set of programmatic instructions stored on a machine readable media, which cause a machine to automatically infer values for the at least one uncompleted entry based upon values of the at least one completed entry, wherein after the set of programmatic instructions execute, the at least one uncompleted entry is completed with inferred values and is thereafter referred to as an inferred entry;
detecting an occurrence of a consolidation output generation event; and
responsive to the occurrence of the consolidation output generation event, executing a data driven programmatic action, which utilizes the completed entries and the inferred entries to produce consolidation output, wherein said consolidation output specifies a modification to the physical network, said modification being a server consolidation of the plurality of servers, said modification resulting in a new defined set of servers, each having new characteristic server capabilities, said new server capabilities representing a new network capability, which new network capability responding to a new network processing requirement of the entity, wherein said tabular data including the completed values and the inferred values that together define the new network requirement.

2. The method of claim 1, wherein said editable graphical user interfaces comprises a spreadsheet program.

3. The method of claim 2, wherein the spreadsheet program is a commercial off-the-shelf (COTS) spreadsheet program.

4. The method of claim 3, wherein the produced consolidation output comprises at least one of a chart, graph, and summary sheet generated by the commercial off-the-shelf (COTS) spreadsheet program.

5. The method of claim 2, wherein the set of programmatic instructions that infer values comprise at least one of a set of spreadsheet macros, a set of spreadsheet programs written in a computer language of an integrated development language built into the spreadsheet program, and a plug-in for the spreadsheet program.

6. The method of claim 1, further comprising:
executing a consolidation action, which is a programmatic action that constructs a consolidation solution for the physical network based upon the tabular data.

7. The method of claim 6, further comprising:
determining a value margin of error for inferring each value of the executing step;
statistically combining the value margins of error to create a solution margin of error; and
including the solution margin of error as part of the consolidation solution.

8. The method of claim 1, wherein the tabular data comprises a plurality of input tables, each input table characterizing capabilities of the physical computing network at a different level of granularity than that used by other ones of the input tables, wherein different ones of the input tables redundantly characterize a same server in different manners, and wherein said set of programmatic instructions that infer values utilize said plurality of input tables.

9. The method of claim 1, wherein said steps of claim 1 are steps performed automatically by at least one machine in accordance with at least one computer program having a plurality of code sections that are executable by the at least one machine, said at least one computer program being stored in a machine readable medium.

10. A consolidation software program comprising:
a set of tables for defining network parameters for a network configuration, said tables including entries for each server in a network, said entries for each server specifying hardware characteristics of each server;
a graphical user interface (GUI) configured for visually presenting the tables and for interactively receiving user input that is placed within the tables;
an inference engine configured to automatically generate values used to populate uncompleted entries of the set of tables based upon values of other entries in the set of tables; and
a solution engine configured to automatically generate at least one alternative configuration to the network configuration based upon table values that include at least one inferred value generated by the inference engine., wherein said alternative configuration consolidates servers relative to the network configuration, wherein said consolidation software program is stored within a machine readable media.

11. The software of claim 10, wherein said editable graphical user interface comprises an interface of a commercial off-the-shelf (COTS) spreadsheet program.

12. The software of claim 11, wherein the solution engine outputs at least one output result table, wherein said spreadsheet program is configured to generate at least one of a chart, graph, and summary sheet from the output result table by leveraging corresponding chart, graph, or summary sheet capabilities of the commercial off-the-shelf (COTS) spreadsheet program.

13. The software of claim 10, wherein said editable graphical user interfaces comprise a commercial off-the-shelf (COTS) database program.

14. The software of claim 10, wherein the tables are indexed tables linked to a software program able to execute structured query language (SQL) queries against the indexed tables.

15. The software of claim 10, further comprising:
an analysis tool configured to monitor the network and to automatically generate a set of values for at least a portion of the entries of the set of tables.

16. A method for generating network characterizing data for a server consolidation (SCON) comprising:
presenting an interface comprising at least one editable input table that comprises a set of fields that together characterize a physical computing network, wherein a format of the at least one editable input table is predefined for server consolidation (SCON) purposes, wherein said at least one editable input table is programmatically linked to a master input table so that completion of the set of fields automatically results in entries of the master input table being filled-in, said master input table providing network characterizing input that drives a solution engine that is a software program configured to generate at least one consolidation solution for the physical computing network;
receiving user input for a plurality of the editable metrics via the tabular interface;
automatically determining at least one entries of the master input table that is initially unfilled by values placed in the set of fields; and
executing a set of programmatically defined inference rules to create inferred values for each of the initially unfilled entries of the master input table, wherein the inference rules utilize filled values of the set of fields when creating values for the initially unfilled entries.

17. The method of claim 16, wherein the at least one editable input table consists of the master input table.

18. The method of claim 17, wherein the at least one editable input table comprises a plurality of input tables that redundantly characterize servers of the physical computing network at different levels of granularity.

19. The method of claim 16, wherein the tabular interface is an interface of a commercial off-the-shelf (COTS) program, said commercial off-the-shelf (COTS) program comprising at least one of a spreadsheet program, a database program, and a reporting program.

20. The method of claim 16, wherein said steps of claim 16 are steps performed automatically by at least one machine in accordance with at least one computer program having a plurality of code sections that are executable by the at least one machine, said at least one computer program being stored in a machine readable medium.
